(19) United States
(12) Patent Application Publication
(10) Pub. No.: US 2022/0161200 A1
(43) Pub. Date: May 26, 2022

(54) HYDROPHILIC COMPOSITE POROUS MEMBRANE

(71) Applicant: TEIJIN LIMITED, Osaka-shi, Osaka (JP)

(72) Inventors: Mami NAMBU, Osaka-shi, Osaka (JP); Yoshikazu IKUTA, Osaka-shi, Osaka (JP); Yu NAGAO, Osaka-shi, Osaka (JP)

(73) Assignee: TEIJIN LIMITED, Osaka-shi, Osaka (JP)

(21) Appl. No.: 17/437,961

(22) PCT Filed: Jan. 28, 2020
(86) PCT No.: PCT/JP2020/002933

§ 371 Date: Sep. 10, 2021

(30) Foreign Application Priority Data
Mar. 14, 2019 (JP) 2019-047536

(51) Int. Cl. B01D 69/02; C08J 9/42; B01D 69/12; B01D 71/26; B01D 71/38; B01D 71/76

(52) U.S. Cl. CPC B01D 69/02; C08J 9/42; B01D 69/12; B01D 71/26; B01D 71/38; B01D 71/76; B01D 2325/20; C08J 2423/02; C08J 2429/06; B01D 2325/02; B01D 2325/04; B01D 2325/36; C08J 2323/02

(57) ABSTRACT

One embodiment of the present invention provides a hydrophilic composite porous membrane including: a polyolefin microporous membrane, and an olefin/vinyl alcohol-based resin with which at least one main surface and inner surfaces of pores of the polyolefin microporous membrane are coated, in which a ratio t/x of a membrane thickness t (μm) to an average pore diameter x (μm), as measured with a perm porometer, is from 50 to 630.

### TECHNICAL FIELD

The present invention relates to a hydrophilic composite porous membrane.

### BACKGROUND ART

Since there are liquids containing particles in various states, it may be required, for example, to detect a particulate substance contained in an extremely small amount or to grasp a change in state. When the amount of the contained particles is extremely small, the concentration of the contained particles is increased for various purposes.

Patent Document 1 discloses that a bundle of polyethylene porous hollow fiber membranes having a surface coated with an ethylene/vinyl alcohol copolymer is used for capturing microorganisms.

Patent Document 2 discloses that a filter membrane having a bubble point pore diameter not exceeding 1.0 μm is used for capturing microorganisms.

Patent Document 3 discloses a method for producing a hydrophilized polymer microporous membrane in which a hydrophilic monomer is radiation-grafted onto the surface of a polymer microporous membrane made of a hydrophobic resin.

Patent Document 4 discloses a hydrophilic microporous membrane obtained by copolymerizing a hydrophilic monomer having one vinyl group and a crosslinking agent having two or more vinyl groups with a polymer microporous membrane by a graft polymerization method.

Patent Document 5 discloses a microporous membrane made of a polyethylene resin having a viscosity average molecular weight of more than 1 million, containing at least one crystal component having a melting peak temperature of 145° C. or higher, and having a porosity of 20 to 95% and an average pore diameter of 0.01 to 10 μm.

Patent Document 6 discloses a separation filter including a highly permeable microporous membrane made of a polyethylene resin and having a thickness of more than 25 μm and equal to or less than 1 mm, an average pore diameter of 0.01 to 10 μm, and a structural factor F of 1.5×10⁷ seconds⁻²·m⁻¹·Pa⁻² or more.

Patent Document 7 discloses a hydrophilic composite porous membrane including a porous structural matrix made of a polyolefin and an ethylene/vinyl alcohol-based copolymer coating layer with which the pore surface of the matrix is coated.

Patent Document 1: Japanese Patent Application Laid-Open (JP-A) No. H11-090184

Patent Document 2: Japanese National-Phase Publication (JP-A) No. 2013-531236

Patent Document 3: Japanese Patent Application Laid-Open (JP-A) No. 2009-183804

Patent Document 4: Japanese Patent Application Laid-Open (JP-A) No. 2003-268152

Patent Document 5: Japanese Patent Application Laid-Open (JP-A) No. 2004-016930

Patent Document 6: Japanese Patent Application Laid-Open (JP-A) No. 2002-265658

Patent Document 7: Japanese Patent Application Laid-Open (JP-A) No. S61-271003

### SUMMARY OF INVENTION

### Technical Problem

In recent years, fine particles of nano-order size have been increasingly used due to various advantages. One of methods for separating fine particles is a centrifugal separation method. However, the centrifugal separation method is a method that requires equipment, labor, and time for a reason of repeating a centrifugal separation operation while changing a centrifugal force, centrifuging a sample in a buffer solution having a density gradient, performing ultra-centrifugal separation, or the like. In addition, a method of separating fine particles using a porous membrane, for example, as in Patent Documents 1 to 7, is indicated as one of methods for separating fine particles, but since this method is a technique of separating fine particles by filtering the fine particles with a membrane, there is a problem that it is per se difficult to filter out particles from a liquid containing an extremely small amount of particles having a small particle size. In addition, when filtration is attempted with a membrane through which fine particles are less likely to pass, there is a problem that clogging occurs and a long time is required for work. Conversely, a membrane with which particles are not filtered with the result that they are contained in a large amount in a filtrate cannot be used to concentrate the particles in the liquid.

An embodiment of the present disclosure has been made under the above circumstances.

An object of an embodiment of the present disclosure is to provide a hydrophilic composite porous membrane that easily and rapidly concentrates particles efficiently, and to solve the problem.

### Solution to Problem

Specific means for solving the problem include the following aspects.

[1] A hydrophilic composite porous membrane containing:

a polyolefin microporous membrane; and

an olefin/vinyl alcohol-based resin with which at least one main surface and inner surfaces of pores of the polyolefin microporous membrane are coated,

wherein a ratio t/x of a membrane thickness t (μm) to an average pore diameter x (μm), as measured with a perm porometer, is from 50 to 630.

[2] The hydrophilic composite porous membrane according to [1], wherein the average pore diameter x is from 0.1 μm to 0.5 μm.

[3] The hydrophilic composite porous membrane according to [1] or [2], wherein a bubble point pore diameter y, as measured with a perm porometer, is more than 0.8 μm and equal to or less than 3 μm.

[4] The hydrophilic composite porous membrane according to any one of [1] to [3], wherein a ratio f/y of a water flow rate f (mL/(min·cm²·MPa)) to a bubble point pore diameter y (μm), as measured with a perm porometer, is from 100 to 480.

[5] The hydrophilic composite porous membrane according to any one of [1] to [4], wherein the membrane thickness t is from 10 μm to 150 μm.

[6] The hydrophilic composite porous membrane according to any one of [1] to [5], which has a surface roughness Ra of from 0.3 μm to 0.7 μm.

[7] The hydrophilic composite porous membrane according to any one of [1] to [6], wherein a bubble point pressure is from 0.02 MPa to 0.15 MPa.

[8] The hydrophilic composite porous membrane according to any one of [1] to [7], wherein a water flow rate f is 20 mL/(min·cm²·MPa) or more.

### Advantageous Effects of Invention

According to an embodiment of the present disclosure, a hydrophilic composite porous membrane that easily and rapidly concentrates particles efficiently is provided.

### BRIEF DESCRIPTION OF DRAWINGS

FIG. 1A is a schematic diagram showing an instrument and an operation for a concentration test.

FIG. 1B is a schematic diagram showing an operation of recovering a suspension remaining upstream of the hydrophilic composite porous membrane using the instrument illustrated in FIG. 1A.

### DESCRIPTION OF EMBODIMENTS

Hereinafter, embodiments of the invention will be described. These descriptions and examples illustrate embodiments and do not limit the scope of the invention. The mechanism of action described in the present disclosure includes presumptions, and whether or not the presumptions are correct does not limit the scope of the invention.

When an embodiment is described with reference to the drawings in the present disclosure, the configuration of the embodiment is not limited to the configuration illustrated in the drawings. In addition, the sizes of members in each drawing are conceptual, and the relative relationship between the sizes of the members is not limited thereto.

In the present disclosure, a numerical range indicated using “to” indicates a range including numerical values described before and after “to” as a lower limit value and an upper limit value, respectively.

In the numerical ranges described in stages in the present disclosure, the upper limit value or the lower limit value described in one numerical range may be replaced with the upper limit value or the lower limit value of any other numerical range described in stages. In addition, in the numerical ranges described in the present disclosure, the upper limit values or the lower limit values of the numerical ranges may be replaced with values shown in Examples.

In the present disclosure, the term “step” includes not only an independent step but also a step that cannot be clearly distinguished from other steps as long as the intended purpose of step is achieved.

In the present disclosure, each component may contain a plurality of corresponding substances. When referring to the amount of each component in a composition in the present disclosure, if there are a plurality of substances corresponding to each component in the composition, the amount means a total amount of the plurality of substances present in the composition unless otherwise specified.

In the present disclosure, “(meth)acryl” means at least one of acryl or methacryl, and “(meth)acrylate” means at least one of acrylate or methacrylate.

In the present disclosure, “monomer unit” means a constituent element of a polymer formed by polymerization of a monomer.

In the present disclosure, “machine direction” means an elongating direction in a membrane, film or sheet manufactured in an elongated shape, and “width direction” means a direction orthogonal to the “machine direction”. In the present disclosure, the “machine direction” is also referred to as the “MD direction”, and the “width direction” is also referred to as the “TD direction”.

In the present disclosure, “main surface” of the membrane, film, or sheet means a wide outer surface other than the outer surface extending in a thickness direction, of the outer surfaces of the membrane, film, or sheet. The membrane, film or sheet includes two main surfaces. In the present disclosure, “side surface” of the membrane, film, or sheet refers to an outer surface extending in the thickness direction, of the outer surfaces of the membrane, film, or sheet.

In the present disclosure, with respect to the hydrophilic composite porous membrane, a side into which a liquid composition flows is referred to as “upstream”, and a side from which the liquid composition flows out is referred to as “downstream”.

<Hydrophilic Composite Porous Membrane>

A hydrophilic composite porous membrane of the present disclosure includes: a polyolefin microporous membrane; and an olefin/vinyl alcohol-based resin with which at least one main surface and inner surfaces of pores of the polyolefin microporous membrane are coated, in which a ratio t/x of a membrane thickness t (μm) to an average pore diameter x (μm), as measured with a perm porometer, is from 50 to 630.

The hydrophilic composite porous membrane of the present disclosure is intended to treat a liquid composition containing water (hereinafter, referred to as an aqueous liquid composition), which may contain particles, and concentrates the liquid composition into an aqueous liquid composition having an increased concentration of particles.

The particles referred to in the present disclosure include inorganic particles, organic particles, biological particles, particles possessed by an organism, particles released by an organism, particles parasitic on an organism, particles infecting an organism, minute organisms, vesicles having a lipid as a membrane, and fragments thereof.

The inorganic particles refer to particles of inorganic compounds, and examples thereof include particles of a metal (alkali metal, alkaline earth metal, transition metal, or the like) or a semimetal (silicon or the like) or a compound thereof (oxide, hydroxide, or the like).

Examples of the organic particles include polymer particles.

Examples of the biological particles include viruses, parts of viruses (e.g., particles obtained by removing an envelope from an enveloped virus), bacteriophages, bacteria, spores, cystoid spores, fungi, mold, yeast, cysts, protozoa, unicellular algae, plant cells, animal cells, cultured cells, hybridomas, tumor cells, blood cells, platelets, organelles (e.g., cell nuclei, mitochondria, vesicles), exosomes, apoptotic bodies, particles of lipid bilayers, particles of lipid monolayers, liposomes, aggregates of proteins, and fragments thereof.

The size of particles to be concentrated by the hydrophilic composite porous membrane of the present disclosure is not limited. A diameter or long axis length of the particles is, for example, 1 nm or more, 5 nm or more, 10 nm or more, or 20 nm or more, and, for example, 100 μm or less, 50 μm or less, 1,000 nm or less, or 800 nm or less.

For the polyolefin microporous membrane in the hydrophilic composite porous membrane of the present disclosure, it is more appropriate that particles to be concentrated by the hydrophilic composite porous membrane have a nano-order size. In this case, the diameter or long axis length of the particles is, for example, 10 nm or more, or 20 nm or more, and, for example, 1,000 nm or less, 800 nm or less, or 500 nm or less.

The polyolefin microporous membrane of the hydrophilic composite porous membrane of the present disclosure is particularly suitable for concentrating particles having a nano-order size.

As the aqueous liquid composition that serves as a liquid to be concentrated (sample) by the hydrophilic composite porous membrane of the present disclosure, for example, a liquid containing particles in a dispersed, suspended or floated state or the like is used. Examples of the liquid include sea water, chemical liquids, factory waste liquids, hot spring water, liquids for water quality inspection, domestic waste water, river water, agricultural water, fishery water, animal (particularly, human) body fluids (for example, blood, serum, plasma, spinal fluid, tears, sweat, urine, pus, nasal mucus, sputum); dilutions of animal (particularly, human) body fluids; liquid compositions obtained by suspending excrement (for example, feces) of an animal (particularly, human) in water; gargling liquids for animals (particularly, human); buffer solutions containing extracts from an organ, a tissue, a mucous membrane, a skin, a squeezed specimen, a swab, and the like of animals (particularly, human); tissue extracts of marine products; water taken from aquaculture ponds for marine products; plant surface swabs or tissue extracts; soil extracts; extracts from plants; extracts from foods; and raw material liquids for pharmaceuticals.

The hydrophilic composite porous membrane of the present disclosure includes a polyolefin microporous membrane, and an olefin/vinyl alcohol-based resin with which at least one main surface and inner surfaces of pores of the polyolefin microporous membrane are coated. The hydrophilic composite porous membrane of the present disclosure may include a member other than the hydrophilic composite porous membrane. Examples of the member other than the hydrophilic composite porous membrane include a sheet-like reinforcing member disposed in contact with a part or all of a main surface or a side surface of the hydrophilic composite porous membrane; and a guide member for mounting the hydrophilic composite porous membrane in a concentration device.

In the hydrophilic composite porous membrane of the present disclosure, at least the main surface on the upstream side during the concentration treatment may be coated with the olefin/vinyl alcohol-based resin, and both the main surfaces are preferably coated with the olefin/vinyl alcohol-based resin.

Exemplary embodiments in which the main surface of the polyolefin microporous membrane is coated with the olefin/vinyl alcohol-based resin include an embodiment in which the main surface of the polyolefin microporous membrane is partially or wholly coated with the olefin/vinyl alcohol-based resin, an embodiment in which openings of the polyolefin microporous membrane are partially or wholly filled with the olefin/vinyl alcohol-based resin, and an embodiment in which the main surface of the polyolefin microporous membrane is partially coated with the olefin/vinyl alcohol-based resin and the openings are partially filled with the olefin/vinyl alcohol-based resin. When the openings of the polyolefin microporous membrane are filled with the olefin/vinyl alcohol-based resin, the olefin/vinyl alcohol-based resin preferably forms a porous structure. Here, the porous structure means a structure in which a large number of micropores are provided inside, the micropores are coupled to each other, and a gas or a liquid can pass from one side to the other side.

Exemplary embodiments in which the inner surfaces of pores of the polyolefin microporous membrane is coated with the olefin/vinyl alcohol-based resin include an embodiment in which wall surfaces of pores of the polyolefin microporous membrane are partially or wholly coated with the olefin/vinyl alcohol-based resin, an embodiment in which the pores of the polyolefin microporous membrane are partially or wholly filled with the olefin/vinyl alcohol-based resin, and an embodiment in which the wall surfaces of the pores of the polyolefin microporous membrane are partially coated with the olefin/vinyl alcohol-based resin and the pores are partially filled with the olefin/vinyl alcohol-based resin. When the pores of the polyolefin microporous membrane are filled with the olefin/vinyl alcohol-based resin, the olefin/vinyl alcohol-based resin preferably forms a porous structure. Here, the porous structure means a structure in which a large number of micropores are provided inside, the micropores are coupled to each other, and a gas or a liquid can pass from one side to the other side.

Concentration of the particles using the hydrophilic composite porous membrane of the present disclosure is performed such that, when the aqueous liquid composition is allowed to pass one main surface to the other main surface of the hydrophilic composite porous membrane, some or all of the particles contained in the aqueous liquid composition do not pass through the hydrophilic composite porous membrane but remain in the aqueous liquid composition at at least any site of the upstream, the upstream-side main surface, and the inside of the pores of the hydrophilic composite porous membrane.

A comparison is made between the aqueous liquid composition before the concentration treatment and the aqueous liquid composition recovered from at least any site of the upstream, the upstream-side main surface, and the inside of the pores of the hydrophilic composite porous membrane after the concentration treatment. When the concentration of the particles contained in the latter aqueous liquid composition is higher, the particles can be said to have been concentrated.

A concentration rate of the particles achieved by the hydrophilic composite porous membrane of the present disclosure is more than 100%, preferably 200% or more, and more preferably 300% or more. The concentration rate is determined from the following formula.

Concentration rate (%)=“particle concentration of aqueous liquid composition recovered from at least any site of upstream, main surface on upstream side, and inside of pores of hydrophilic composite porous membrane after concentration treatment”±“particle concentration of aqueous liquid composition before concentration treatment”×100

Although the detailed mechanism is not necessarily clear, it is presumed that, when the hydrophilic composite porous membrane of the present disclosure has the olefin/vinyl alcohol-based resin on the upstream-side main surface and the inner surfaces of the pores, the particles present at at least any site of the upstream, the upstream-side main surface, and the inside of the pores of the hydrophilic composite porous membrane are easily recovered, and thus that the concentration rate of the particles is improved.

In the hydrophilic composite porous membrane of the present disclosure, a ratio t/x of a membrane thickness t (μm) to an average pore diameter x (μm), as measured with a perm porometer, is from 50 to 630.

When t/x of the hydrophilic composite porous membrane is less than 50, the membrane thickness t is too small for the average pore diameter x, or the average pore diameter x is too large for the membrane thickness t, and thus the particles easily pass through the hydrophilic composite porous membrane, so that a residual rate of the particles remaining at at least any site of the upstream, the upstream-side main surface, and the inside of the pores of the hydrophilic composite porous membrane (hereinafter, simply referred to as “residual rate of the particles”) is poor, and, as a result, the concentration rate of the particles is poor. From this viewpoint, t/x is 50 or more, preferably 80 or more, and more preferably 100 or more.

When t/x of the hydrophilic composite porous membrane is more than 630, the membrane thickness t is too large for the average pore diameter x, or the average pore diameter x is too small for the membrane thickness t, and thus the aqueous liquid composition is less likely to pass through the hydrophilic composite porous membrane, and it takes time for the aqueous liquid composition to pass through the hydrophilic composite porous membrane (that is, it takes time to concentrate the aqueous liquid composition). From this viewpoint, t/x is 630 or less, preferably 600 or less, more preferably 500 or less, and further preferably 400 or less.

When the hydrophilic composite porous membrane of the present disclosure is used, the particles can be concentrated easily and rapidly as compared with when the centrifugal separation method is used. When the hydrophilic composite porous membrane of the present disclosure is used, the particles can be concentrated rapidly and efficiently as compared with when conventional porous membranes are used.

Hereinafter, the hydrophilic composite porous membrane, the polyolefin microporous membrane, and the olefin/vinyl alcohol-based resin of the present disclosure will be described in detail.

[Hydrophilic Composite Porous Membrane]

In the hydrophilic composite porous membrane, a contact angle of water (also referred to as a water contact angle) as measured by the following measurement method is preferably 90 degrees or less on one side or both sides. The water contact angle is preferably smaller. “Hydrophilic” refers to a state where the water contact angle is smaller than that in a so-called hydrophobic state, and is preferably a state where the water contact angle is 90 degrees or less. More preferably, the hydrophilic composite porous membrane is so hydrophilic that the contact angle of water, when attempted to be measured on one side or both sides under the following measurement conditions, cannot be measured because a water droplet penetrates into the membrane.

Here, “water contact angle” is a value as measured by the following measurement method.

The hydrophilic composite porous membrane is left in an environment at a temperature of 25° C. and a relative humidity of 60% for 24 hours or more to adjust the humidity. Thereafter, a water droplet of 1 μL of ion-exchanged water is dropped on the surface of the porous membrane with a syringe under an environment at the same temperature and the same humidity, and a contact angle 30 seconds after dropping of the water droplet is measured by a θ/2 method using a fully automatic contact angle meter (Kyowa Interface Science Co., Ltd., model number: Drop Master DM 500).

The thickness t of the hydrophilic composite porous membrane is preferably 10 μm or more, more preferably 15 μm or more, further preferably 20 μm or more, and still further preferably 30 μm or more from the viewpoint of increasing the strength of the hydrophilic composite porous membrane and the viewpoint of increasing the residual rate of the particles. The thickness t of the hydrophilic composite porous membrane is preferably 150 μm or less, more preferably 100 μm or less, further preferably 80 μm or less, and still further preferably 70 μm or less from the viewpoint of shortening a time necessary for the aqueous liquid composition to pass through the hydrophilic composite porous membrane (hereinafter, referred to as treatment time for the aqueous liquid composition).

The thickness t of the hydrophilic composite porous membrane is determined by measuring values at 20 points with a contact type membrane thickness meter and averaging the measured values.

The average pore diameter x of the hydrophilic composite porous membrane as measured with a perm porometer is preferably 0.1 μm or more, more preferably 0.15 μm or more, and further preferably 0.2 μm or more, from the viewpoint of shortening the treatment time for the aqueous liquid composition and the viewpoint of easily recovering the particles remaining in the pores of the hydrophilic composite porous membrane. The average pore diameter x of the hydrophilic composite porous membrane as measured with a perm porometer is preferably 0.5 μm or less, more preferably 0.45 μm or less, and further preferably 0.4 μm or less from the viewpoint of increasing the residual rate of the particles.

The average pore diameter x of the hydrophilic composite porous membrane as measured with a perm porometer is determined by a half dry method specified in ASTM E1294-89 using a perm porometer (PMI, model: CFP-1200 AEXL) and using Galwick (surface tension: 15.9 dyn/cm) manufactured by PMI as an immersion liquid. When only one main surface of the hydrophilic composite porous membrane is coated with the olefin/vinyl alcohol-based resin, the main surface coated with the olefin/vinyl alcohol-based resin is placed toward a pressurizing part of the perm porometer, and the measurement is performed.

A bubble point pore diameter y of the hydrophilic composite porous membrane as measured with a perm porometer is preferably more than 0.8 μm, more preferably 0.9 μm or more, and further preferably 1.0 μm or more, from the viewpoint of shortening the treatment time for the aqueous liquid composition and the viewpoint of easily recovering the particles remaining in the pores of the hydrophilic composite porous membrane. The bubble point pore diameter y of the hydrophilic composite porous membrane as measured with a perm porometer is preferably 3 μm or less, more preferably 2.5 μm or less, and further preferably 2.2 μm or less from the viewpoint of increasing the residual rate of the particles.

The bubble point pore diameter y of the hydrophilic composite porous membrane as measured with a perm porometer is determined by a bubble point method (ASTM F316-86 and JIS K3832) using a perm porometer (PMI, model: CFP-1200 AEXL). However, the value is determined by changing the immersion liquid at the time of the test to Galwick (surface tension: 15.9 dyn/cm) manufactured by PMI. When only one main surface of the hydrophilic composite porous membrane is coated with the olefin/vinyl alcohol-based resin, the main surface coated with the olefin/vinyl alcohol-based resin is placed toward a pressurizing part of the perm porometer, and the measurement is performed.

A bubble point pressure of the hydrophilic composite porous membrane is, for example, 0.01 MPa or more and 0.20 MPa or less, or 0.02 MPa to 0.15 MPa.

In the present disclosure, the bubble point pressure of the hydrophilic composite porous membrane is a value determined by immersing the polyolefin microporous membrane in ethanol, performing a bubble point test according to the bubble point test method of JIS K3832:1990, while changing the liquid temperature at the time of the test to 24±2° C. and the applied pressure is increased at a pressure increase rate of 2 kPa/sec. When only one main surface of the hydrophilic composite porous membrane is coated with the olefin/vinyl alcohol-based resin, the main surface coated with the olefin/vinyl alcohol-based resin is placed toward a pressurizing part, and the measurement is performed.

A water flow rate f (mL/(min·cm²·MPa)) of the hydrophilic composite porous membrane is preferably 20 or more, more preferably 50 or more, further preferably 100 or more, still further preferably 200 or more, and particularly preferably 220 or more from the viewpoint of shortening the treatment time for the aqueous liquid composition. The water flow rate f (mL/(min·cm²·MPa)) of the hydrophilic composite porous membrane is preferably 1,000 or less, more preferably 800 or less, and further preferably 700 or less from the viewpoint of increasing the residual rate of the particles.

The water flow rate f of the hydrophilic composite porous membrane is determined by allowing 100 mL of water to permeate a sample set on a liquid permeation cell having a constant liquid permeation area (cm²) at a constant differential pressure (20 kPa), measuring a time (sec) necessary for 100 mL of water to permeate the sample, and subjecting the measured value to unit conversion. When only one main surface of the hydrophilic composite porous membrane is coated with the olefin/vinyl alcohol-based resin, water is allowed to permeate from the main surface coated with the olefin/vinyl alcohol-based resin to the main surface not coated with the olefin/vinyl alcohol-based resin, and the measurement is performed.

In the hydrophilic composite porous membrane, the ratio f/y of the water flow rate f (mL/(min·cm²·MPa)) to the bubble point pore diameter y (μm) is preferably 100 or more, more preferably 150 or more, and further preferably 200 or more, from the viewpoint of shortening the treatment time for the aqueous liquid composition. In the hydrophilic composite porous membrane, the ratio f/y of the water flow rate f (mL/(min·cm²·MPa)) to the bubble point pore diameter y (μm) is preferably 480 or less, more preferably 400 or less, and further preferably 350 or less, from the viewpoint of increasing the residual rate of the particles.

From the viewpoint of increasing a recovery rate of the particles, the hydrophilic composite porous membrane has a surface roughness Ra of preferably 0.3 μm or more, and more preferably 0.4 μm or more, at least on the main surface on the upstream side during the concentration treatment.

From the viewpoint of increasing the residual rate of the remaining particles, the hydrophilic composite porous membrane has a surface roughness Ra of preferably 0.7 μm or less, and more preferably 0.6 μm or less, at least on the main surface on the upstream side during the concentration treatment.

The surface roughness Ra of the hydrophilic composite porous membrane is determined by measuring surface roughnesses at three random places on the surface of a sample in a non-contact manner using a light wave interference type surface roughness meter (Zygo Corporation, NewView 5032), and using analysis software (optional application: Advance Texture.app) for roughness evaluation.

A Gurley value (seconds/100 mL·μm) per unit thickness of the hydrophilic composite porous membrane is, for example, 0.001 to 5, 0.01 to 3, or 0.05 to 1. The Gurley value of the hydrophilic composite porous membrane is a value as measured according to JIS P8117:2009.

A porosity of the hydrophilic composite porous membrane is, for example, 70% to 90%, 72% to 89%, or 74% to 87%. The porosity of the hydrophilic composite porous membrane is determined according to the following calculation method. Specifically, when constituent materials are a, b, c, . . . , and n, masses of the respective constituent materials are Wa, Wb, Wc, . . . , and Wn (g/cm²), true densities of the constituent materials are da, db, dc, . . . , and do (g/cm³), and the membrane thickness is t (cm), a porosity c (%) is determined according to the following formula.

ε={1−(Wa/da+Wb/db+Wc/dc+ . . . +Wn/dn)/t}×100

The hydrophilic composite porous membrane is preferably less likely to curl from the viewpoint of handleability. From the viewpoint of suppressing curling of the hydrophilic composite porous membrane, both the main surfaces of the hydrophilic composite porous membrane are preferably coated with the olefin/vinyl alcohol-based resin.

[Polyolefin Microporous Membrane]

The polyolefin microporous membrane in the present disclosure is a microporous membrane containing a polyolefin.

The microporous membrane means a membrane having a structure in which a large number of micropores are provided inside and the micropores are coupled to each other, and through which a gas or a liquid can pass from one surface to the other surface.

The polyolefin microporous membrane may be hydrophobic or hydrophilized. In particular, when the polyolefin microporous membrane is hydrophobic, the polyolefin microporous membrane is coated with the olefin/vinyl alcohol-based resin and thus exhibits hydrophilicity. The “hydrophilicity” is as defined above.

One embodiment of the polyolefin microporous membrane is a porous sheet made of a fibrous material, and examples thereof include a nonwoven fabric and paper. Examples of the fibrous material include fibrous materials of polyolefins such as polyethylene and polypropylene.

The polyolefin contained in the polyolefin microporous membrane is not particularly limited, and examples thereof include polyethylene, polypropylene, polybutylene, polymethylpentene, and a copolymer of polypropylene and polyethylene. Among them, polyethylene is preferable, and high-density polyethylene, a mixture of high-density polyethylene and ultra-high molecular weight polyethylene, and the like are suitable. One embodiment of the polyolefin microporous membrane is a polyethylene microporous membrane containing only polyethylene as the polyolefin.

A weight average molecular weight (Mw) of the polyolefin contained in the polyolefin microporous membrane is, for example, 100,000 to 5 million. When the Mw of the polyolefin is 100,000 or more, sufficient mechanical characteristics can be imparted to the microporous membrane. When the Mw of the polyolefin is 5 million or less, the microporous membrane is easily molded.

One embodiment of the polyolefin microporous membrane is a microporous membrane containing a polyolefin composition (in the present disclosure, which means a mixture of polyolefins containing two or more polyolefins, and is referred to as a polyethylene composition when the polyolefin contained is only polyethylene). The polyolefin composition has an effect of forming a network structure with fibrillation during stretching and increasing the porosity of the polyolefin microporous membrane.

The polyolefin composition contains ultra-high molecular weight polyethylene having a weight average molecular weight of 9×10⁵ or more in an amount of preferably 5% by mass to 40% by mass, more preferably 10% by mass to 35% by mass, and further preferably 15% by mass to 30% by mass, based on the total amount of the polyolefin.

The polyolefin composition is preferably a polyolefin composition obtained by mixing ultra-high molecular weight polyethylene having a weight average molecular weight of 9×10⁵ or more and high-density polyethylene having a weight average molecular weight of 2×10⁵ to 8×10⁵ and a density of 920 kg/m³ to 960 kg/m³ at a mass ratio of 5:95 to 40:60 (more preferably 10:90 to 35:65, and even more preferably 15:85 to 30:70).

In the polyolefin composition, the weight average molecular weight of the entire polyolefin is preferably 2×10⁵ to 2×10⁶.

The weight average molecular weight of the polyolefin constituting the polyolefin microporous membrane is obtained by dissolving the polyolefin microporous membrane in o-dichlorobenzene under heating, and performing measurement by gel permeation chromatography (system: Alliance GPC 2000 manufactured by Waters Corporation, column: GMH6-HT and GMH6-HTL) under the conditions of a column temperature of 135° C. and a flow rate of 1.0 mL/min. Molecular weight monodisperse polystyrene (manufactured by Tosoh Corporation) is used for calibration of the molecular weight.

One embodiment of the polyolefin microporous membrane is a microporous membrane containing polypropylene from the viewpoint of having heat resistance such that the polyolefin microporous membrane does not break easily when exposed to a high temperature.

One embodiment of the polyolefin microporous membrane is a polyolefin microporous membrane containing at least a mixture of polyethylene and polypropylene.

One embodiment of the polyolefin microporous membrane is a polyolefin microporous membrane having a laminated structure of two or more layers, in which at least one layer contains polyethylene and at least one layer contains polypropylene.

The surface of the polyolefin microporous membrane may be subjected to various surface treatments for the purpose of improving the wettability of a coating liquid used for coating the polyolefin microporous membrane with the olefin/vinyl alcohol-based resin. Examples of the surface treatment for the polyolefin microporous membrane include a corona treatment, a plasma treatment, a flame treatment, and an ultraviolet irradiation treatment.

—Physical Properties of Polyolefin Microporous Membrane—

The thickness of the polyolefin microporous membrane is preferably 10 μm or more, more preferably 15 μm or more, and further preferably 20 μm or more from the viewpoint of increasing the strength of the polyolefin microporous membrane and the viewpoint of increasing the residual rate of the particles. The thickness of the polyolefin microporous membrane is preferably 150 μm or less, more preferably 120 μm or less, further preferably 100 μm or less, particularly preferably 80 μm or less, and still further preferably 70 μm or less from the viewpoint of shortening the treatment time for the aqueous liquid composition. The method for measuring the thickness of the polyolefin microporous membrane is the same as the method for measuring the thickness t of the hydrophilic composite porous membrane.

The average pore diameter of the polyolefin microporous membrane as measured with a perm porometer is preferably 0.1 μm or more, more preferably 0.15 μm or more, and further preferably 0.2 μm or more, from the viewpoint of shortening the treatment time for the aqueous liquid composition and the viewpoint of easily recovering the particles remaining in the pores of the hydrophilic composite porous membrane. The average pore diameter of the polyolefin microporous membrane measured with the perm porometer is preferably 0.8 μm or less, more preferably 0.7 μm or less, and further preferably 0.6 μm or less from the viewpoint of increasing the residual rate of the particles. The average pore diameter of the polyolefin microporous membrane measured with the perm porometer is a value determined by a half dry method defined in ASTM E 1294-89 using a perm porometer, and the details of the measurement method are the same as the measurement method related to the average pore diameter x of the hydrophilic composite porous membrane.

The bubble point pore diameter of the polyolefin microporous membrane as measured with the perm porometer is preferably more than 0.8 μm, more preferably 0.9 μm or more, and further preferably 1.0 μm or more, from the viewpoint of shortening the treatment time for the aqueous liquid composition and the viewpoint of easily recovering the particles remaining in the pores of the hydrophilic composite porous membrane. The bubble point pore diameter of the polyolefin microporous membrane as measured with the perm porometer is preferably 3 μm or less, more preferably 2.8 μm or less, and further preferably 2.5 μm or less from the viewpoint of increasing the residual rate of the particles. The bubble point pore diameter of the polyolefin microporous membrane as measured with the perm porometer is a value determined by the bubble point method defined in ASTM F 316-86 and HS K 3832 using a perm porometer, and the details of the measurement method are the same as those of the measurement method for the bubble point pore diameter y of the hydrophilic composite porous membrane.

The water flow rate (mL/(min·cm²·MPa)) of the polyolefin microporous membrane is preferably 20 or more, more preferably 50 or more, and further preferably 100 or more from the viewpoint of shortening the treatment time for the aqueous liquid composition. The water flow rate (mL/(min·cm²·MPa)) of the polyolefin microporous membrane is preferably 1,000 or less, more preferably 800 or less, and further preferably 700 or less from the viewpoint of increasing the residual rate of the particles.

The method for measuring the water flow rate of the polyolefin microporous membrane is the same as the method for measuring the water flow rate f of the hydrophilic composite porous membrane. However, since the polyolefin microporous membrane is hydrophobic as it is, the polyolefin microporous membrane immersed in ethanol in advance and dried at room temperature is used as a sample, and the sample set on the liquid permeation cell is wetted with a small amount (0.5 ml) of ethanol, then the measurement is performed.

The polyolefin microporous membrane has a surface roughness Ra of preferably 0.3 μm or more, and more preferably 0.4 μm or more on one side or both sides.

The polyolefin microporous membrane has a surface roughness Ra of preferably 0.7 μm or less, and more preferably 0.6 μm or less on one side or both sides.

The surface roughness Ra of the polyolefin microporous membrane is an arithmetic average height of a roughness curve, and the details of the measurement method are the same as those of the measurement method for the surface roughness Ra of the hydrophilic composite porous membrane.

A Gurley value (seconds/100 mL·μm) per unit thickness of the polyolefin microporous membrane is, for example, 0.001 to 5, 0.01 to 3, or 0.05 to 1. The Gurley value of the polyolefin microporous membrane is a value as measured according to JIS P8117:2009.

A porosity of the polyolefin microporous membrane is, for example, 70% to 90%, 72% to 89%, or 74% to 87%. The porosity of the polyolefin microporous membrane is determined according to the following calculation method. Specifically, when constituent materials are a, b, c, . . . , and n, masses of the respective constituent materials are Wa, Wb, Wc, . . . , and Wn (g/cm²), true densities of the constituent materials are da, db, dc, . . . , and do (g/cm³), and the membrane thickness is t (cm), a porosity ε (%) is determined according to the following formula.

ε={1−(Wa/da+Wb/db+Wc/dc+ . . . +Wn/dn)/t}×100

A BET specific surface area of the polyolefin microporous membrane is, for example, 1 m²/g to 40 m²/g, 2 m²/g to 30 m²/g, or 3 m²/g to 20 m²/g. The BET specific surface area of the polyolefin microporous membrane is a value determined by measuring an adsorption isotherm at a set relative pressure of 1.0×10⁻³ to 0.35 by a nitrogen gas adsorption method at a liquid nitrogen temperature using a specific surface area measuring apparatus (model: BELSORP-mini) manufactured by MicrotracBEL Corporation, and analyzing the adsorption isotherm by a BET method.

—Method for Producing Polyolefin Microporous Membrane—

The polyolefin microporous membrane can be produced, for example, by a production method including the following steps (I) to (IV):

Step (I): a step of preparing a solution containing a polyolefin composition and a volatile solvent having a boiling point of less than 210° C. at atmospheric pressure;

Step (II): a step of melt-kneading the solution, extruding the obtained melt-kneaded product from a die, and cooling and solidifying the extrudate to obtain a first gel-like molded product;

Step (III): a step of stretching (primary stretching) the first gel-like molded product in at least one direction and drying the solvent to obtain a second gel-like molded product; and

Step (IV): a step of stretching (secondary stretching) the second gel-like molded product in at least one direction.

Step (I) is a step of preparing a solution containing a polyolefin composition and a volatile solvent having a boiling point of less than 210° C. at atmospheric pressure. The solution is preferably a thermoreversible sol-gel solution, and the polyolefin composition is dissolved in a solvent under heating to be solated, thereby preparing a thermoreversible sol-gel solution. The volatile solvent having a boiling point of less than 210° C. at atmospheric pressure is not particularly limited as long as it is a solvent capable of sufficiently dissolving the polyolefin. Examples of the volatile solvent include tetralin (206° C. to 208° C.), ethylene glycol (197.3° C.), decalin (decahydronaphthalene, 187° C. to 196° C.), toluene (110.6° C.), xylene (138° C. to 144° C.), diethyltriamine (107° C.), ethylenediamine (116° C.), dimethylsulfoxide (189° C.), and hexane (69° C.), and decalin or xylene is preferable (the temperatures in parentheses are their boiling points at atmospheric pressure). The volatile solvents may be used singly or, two or more thereof may be used in combination.

The polyolefin composition used in step (I) (in the present disclosure, which means a mixture of polyolefins containing two or more polyolefins, and is referred to as a polyethylene composition when the polyolefin contained is only polyethylene) preferably contains polyethylene, and more preferably is a polyethylene composition.

In the solution prepared in step (I), the polyolefin concentration of the polyolefin composition is preferably 10% by mass to 40% by mass, and more preferably 15% by mass to 35% by mass from the viewpoint of controlling the porous structure of the polyolefin microporous membrane. When the polyolefin concentration of the polyolefin composition is 10% by mass or more, the occurrence of cutting can be suppressed in the process for forming the polyolefin microporous membrane, and the dynamic strength of the polyolefin microporous membrane is increased to improve the handleability. When the polyolefin concentration of the polyolefin composition is 40% by mass or less, pores of the polyolefin microporous membrane are easily formed.

Step (II) is a step of melt-kneading the solution prepared in step (I), extruding the obtained melt-kneaded product from a die, and cooling and solidifying the extrudate to obtain a first gel-like molded product. In Step (II), for example, the melt-kneaded product is extruded from a die in a temperature range from the melting point of the polyolefin composition to the melting point +65° C. to obtain an extrudate, and then the extrudate is cooled to obtain a first gel-like molded product. The first gel-like molded product is preferably shaped into a sheet. The cooling may be performed by immersion in water or an organic solvent, or may be performed by contact with a cooled metal roll, and is generally performed by immersion in the volatile solvent used in step (I).

Step (III) is a step of stretching (primary stretching) the first gel-like molded product in at least one direction and drying the solvent to obtain a second gel-like molded product. The stretching step in step (III) is preferably biaxial stretching, and may be sequential biaxial stretching in which longitudinal stretching and transverse stretching are separately performed, or simultaneous biaxial stretching in which longitudinal stretching and transverse stretching are simultaneously performed. A stretch ratio for the primary stretching (product of a longitudinal stretch ratio and a lateral stretch ratio) is preferably 1.1 times to 3 times, and more preferably 1.1 times to 2 times, from the viewpoint of controlling the porous structure of the polyolefin microporous membrane. The temperature during the primary stretching is preferably 75° C. or lower. The drying step in step (III) is performed without any particular limitation as long as the drying temperature is a temperature at which the second gel-like molded product is not deformed, but is preferably performed at 60° C. or lower.

The stretching step and the drying step in step (III) may be performed simultaneously or stepwise. For example, the primary stretching may be performed while preliminary drying may be performed, and then main drying may be performed. Alternatively, the primary stretching may be performed between the preliminary drying and the main drying. The primary stretching can also be performed in a state where drying is controlled and the solvent remains in a suitable state.

Step (IV) is a step of stretching (secondary stretching) the second gel-like molded product in at least one direction. The stretching step of step (IV) is preferably biaxial stretching. The stretching step of step (IV) may be any of: sequential biaxial stretching in which longitudinal stretching and transverse stretching are separately performed; simultaneous biaxial stretching in which longitudinal stretching and transverse stretching are simultaneously performed; a step of stretching the second gel-like molded product a plurality of times in the longitudinal direction and then stretching it in the lateral direction; a step of stretching the second gel-like molded product in the longitudinal direction and stretching it a plurality of times in the transverse direction; and a step of sequentially performing biaxial stretching and then further performing stretching once or a plurality of times in the longitudinal direction and/or the lateral direction.

A stretch ratio for the secondary stretching (product of the longitudinal stretch ratio and the lateral stretch ratio) is preferably 5 to 90 times, and more preferably 10 to 60 times, from the viewpoint of controlling the porous structure of the polyolefin microporous membrane. A stretching temperature for the secondary stretching is preferably 90° C. to 135° C., and more preferably 90° C. to 130° C. from the viewpoint of controlling the porous structure of the polyolefin microporous membrane.

After step (IV), heat fixation treatment may be performed. A heat fixation temperature is preferably 110° C. to 160° C., and more preferably 120° C. to 150° C., from the viewpoint of controlling the porous structure of the polyolefin microporous membrane.

After the heat fixation treatment, the solvent remaining in the polyolefin microporous membrane may be further subjected to an extraction treatment and an annealing treatment. The extraction treatment for the remaining solvent is performed, for example, by immersing the sheet after the heat fixation treatment in a methylene chloride bath to elute the remaining solvent in methylene chloride. In the polyolefin microporous membrane immersed in the methylene chloride bath, methylene chloride is preferably removed by drying after the polyolefin microporous membrane is lifted from the methylene chloride bath. The annealing treatment is performed by conveying the polyolefin microporous membrane on a roller heated to, for example, 100° C. to 140° C. after the extraction treatment for the remaining solvent.

Each of the conditions in steps (I) to (IV) is controlled, thereby making it possible to produce a polyolefin microporous membrane having a ratio t/x of the membrane thickness t (μm) to the average pore diameter x (μm) of 50 to 600. For example, the ratio t/x can be controlled to 50 or more by decreasing the longitudinal stretch ratio. For example, the ratio t/x can be controlled to 600 or less by increasing the longitudinal stretch ratio.

[Olefin/Vinyl Alcohol-Based Resin]

The olefin/vinyl alcohol-based resin in the present disclosure is used to easily recover particles remaining at at least any site of the upstream, the upstream-side main surface, and the pores of the hydrophilic composite porous membrane.

The olefin/vinyl alcohol-based resin may be one kind or two or more kinds.

Examples of the olefin constituting the olefin/vinyl alcohol-based resin include ethylene, propylene, butene, pentene, hexene, heptene, octene, nonene, and decene. The olefin is preferably an olefin having 2 to 6 carbon atoms, more preferably an α-olefin having 2 to 6 carbon atoms, further preferably an α-olefin having 2 to 4 carbon atoms, and particularly preferably ethylene. The olefin unit contained in the olefin/vinyl alcohol-based resin may be one kind or two or more kinds.

The olefin/vinyl alcohol-based resin may contain a monomer other than olefin and vinyl alcohol as a constituent unit. Examples of the monomer other than olefin and vinyl alcohol include at least one acrylic monomer selected from the group consisting of (meth)acrylic acid, (meth)acrylic acid salts, and (meth)acrylic acid esters; and styrene monomers such as styrene, meta-chlorostyrene, para-chlorostyrene, para-fluorostyrene, para-methoxystyrene, meta-tert-butoxystyrene, para-tert-butoxystyrene, para-vinylbenzoic acid, and para-methyl-a-methylstyrene. One, or two or more of these monomer units may be contained in the olefin/vinyl alcohol-based resin.

The olefin/vinyl alcohol-based resin may contain a monomer other than olefin and vinyl alcohol as a constituent unit, but, from the viewpoint of less irritation to the particles and the viewpoint of easily recovering the particles remaining in the pores of the hydrophilic composite porous membrane, a total proportion of the olefin unit and the vinyl alcohol unit is preferably 85% by mol or more, more preferably 90% by mol or more, further preferably 95% by mol or more, and particularly preferably 100% by mol. As the olefin/vinyl alcohol-based resin, a binary copolymer of olefin and vinyl alcohol is preferable (here, preferred embodiments of the olefin are as described above), and a binary copolymer of ethylene and vinyl alcohol is more preferable.

A proportion of the olefin unit in the olefin/vinyl alcohol-based resin is preferably 20% by mol to 55% by mol. When the proportion of the olefin unit is 20% by mol or more, the olefin/vinyl alcohol-based resin is less likely to be dissolved in water. From this viewpoint, the proportion of the olefin unit is more preferably 23% by mol or more, and further preferably 25% by mol or more. On the other hand, when the proportion of the olefin unit is 55% by mol or less, the olefin/vinyl alcohol-based resin has higher hydrophilicity. From this viewpoint, the proportion of the olefin unit is more preferably 52% by mol or less, and further preferably 50% by mol or less.

Examples of commercially available products of the olefin/vinyl alcohol-based resin include “Soarnol” series manufactured by The Nippon Synthetic Chemical Industry Co., Ltd. and “Eval” series manufactured by Kuraray Co., Ltd.

An amount of the olefin/vinyl alcohol-based resin adhered to the polyolefin microporous membrane is, for example, 0.01 g/m² to 5 g/m², 0.02 g/m² to 2 g/m², or 0.03 g/m² to 1 g/m². The amount of the olefin/vinyl alcohol-based resin adhered to the polyolefin microporous membrane is a value (Wa-Wb) obtained by subtracting a basis weight Wb (g/m²) of the polyolefin microporous membrane from a basis weight Wa (g/m²) of the hydrophilic composite porous membrane.

—Method for Producing Hydrophilic Composite Porous Membrane—

The method for producing the hydrophilic composite porous membrane is not particularly limited. Examples of general production methods includes a method of applying a coating liquid containing an olefin/vinyl alcohol-based resin to a polyolefin microporous membrane, drying the coating liquid, and coating the polyolefin microporous membrane with the olefin/vinyl alcohol-based resin; and a method of graft-polymerizing a hydrophilic monomer on a polyolefin microporous membrane and coating the polyolefin microporous membrane with an olefin/vinyl alcohol-based resin.

The coating liquid can be prepared by stirring and dispersing the olefin/vinyl alcohol-based resin in a solvent having a temperature increased to a temperature equal to or higher than the melting point of the olefin/vinyl alcohol-based resin.

The solvent is not particularly limited as long as it is a good solvent for the olefin/vinyl alcohol-based resin, and specific examples thereof include a 1-propanol aqueous solution, a 2-propanol aqueous solution, an N,N-dimethylformamide aqueous solution, a dimethyl sulfoxide aqueous solution, and an ethanol aqueous solution. A ratio of the organic solvent in the aqueous solution is preferably in a range of 30% by mass to 70% by mass.

The concentration of the olefin/vinyl alcohol-based resin when the coating liquid containing the olefin/vinyl alcohol-based resin is applied to the polyolefin microporous membrane is preferably 0.01% by mass to 5% by mass. When the concentration of the olefin/vinyl alcohol-based resin is 0.01% by mass or more, hydrophilicity can be imparted to the polyolefin microporous membrane. From such a viewpoint, the concentration of the olefin/vinyl alcohol-based resin is more preferably 0.05% by mass or more, and further preferably 0.1% by mass or more. On the other hand, when the concentration of the olefin/vinyl alcohol-based resin is 5% by mass or less, the water flow rate in the produced hydrophilic composite porous membrane is large. From such a viewpoint, the concentration of the olefin/vinyl alcohol-based resin is more preferably 3% by mass or less, and further preferably 2% by mass or less.

Examples of the coating method include an immersion method, a knife coater method, a gravure coater method, a screen printing method, a Meyer bar method, a die coater method, a reverse roll coater method, an inkjet method, a spray method, and a roll coater method. In addition, by adjusting the temperature of the coating liquid at the time of coating, a layer of the olefin/vinyl alcohol-based resin can be stably obtained. Here, the temperature of the coating liquid is not particularly limited, but is preferably in a range of 5° C. to 40° C.

The temperature at which the coating liquid is dried is preferably 25° C. to 100° C. When the drying temperature is 25° C. or higher, the time necessary for drying can be shortened. From such a viewpoint, the dry concentration is more preferably 40° C. or higher, and further preferably 50° C. or higher. On the other hand, when the drying temperature is 100° C. or lower, shrinkage of the polyolefin microporous membrane is less likely to occur. From such a viewpoint, the drying temperature is more preferably 90° C. or lower, and further preferably 80° C. or lower.

The hydrophilic composite porous membrane may contain a surfactant, a wetting agent, an antifoaming agent, a pH adjusting agent, a coloring agent, and the like.

### EXAMPLES

Hereinafter, the hydrophilic composite porous membrane of the present disclosure will be described more specifically with reference to Examples.

Materials, amounts used, proportions, treatment procedures, and the like presented in the following Examples can be appropriately changed without departing from the gist of the present disclosure. Therefore, the scope of the hydrophilic composite porous membrane of the present disclosure should not be construed as being limited by the specific examples which will be described below.

<Preparation of Hydrophilic Composite Porous Membrane>

### Example 1

—Preparation of Polyethylene Microporous Membrane—

A polyethylene composition was prepared by mixing 3.75 parts by mass of ultra-high molecular weight polyethylene (hereinafter referred to as “UHMWPE”) having a weight average molecular weight (Mw) of 4.6 million with 21.25 parts by mass of high-density polyethylene (hereinafter referred to as “HDPE”) having a weight average molecular weight (Mw) of 560,000 and a density of 950 kg/m³. The polyethylene composition and decalin were mixed so that the polyethylene concentration was 25% by mass to prepare a polyethylene solution.

The polyethylene solution was extruded from a die at a temperature of 147° C. into a sheet, and then the extrudate was cooled in a water bath at a water temperature of 20° C. to obtain a first gel-like sheet.

The first gel-like sheet was preliminarily dried in a temperature atmosphere at 70° C. for 10 minutes, then subjected to primary stretching at 1.8 times in the MD direction, and then subjected to main drying in a temperature atmosphere at 57° C. for 5 minutes to obtain a second gel-like sheet (base tape) (an amount of the solvent remaining in the second gel-like sheet was less than 1%). Next, as secondary stretching, the second gel-like sheet (base tape) was stretched at a magnification of 4 times at a temperature of 90° C. in the MD direction, subsequently stretched at a magnification of 9 times at a temperature of 125° C. in the TD direction, and then immediately subjected to a heat treatment (heat fixation) at 144° C.

The decalin in the sheet was extracted while the heat-fixed sheet was continuously immersed for 30 seconds in each of two tanks into which a methylene chloride bath was divided. After the sheet was conveyed from the methylene chloride bath, methylene chloride was removed by drying in a temperature atmosphere at 40° C. In this way, a polyethylene microporous membrane was obtained.

—Hydrophilization Treatment for Polyethylene Microporous Membrane—

As an olefin/vinyl alcohol-based resin, an ethylene/vinyl alcohol binary copolymer (Soarnol DC 3203R manufactured by The Nippon Synthetic Chemical Industry Co., Ltd., ethylene unit: 32% by mol (hereinafter, referred to as EVOH); olefin/vinyl alcohol-based resin) was prepared. The EVOH was dissolved in a mixed solvent of 1-propanol and water (1-propanol:water=3:2 [volume ratio]) so that the concentration of the EVOH was 0.2% by mass, to obtain a coating liquid.

The polyethylene microporous membrane fixed to a metal frame was immersed in the coating liquid to impregnate the pores of the polyethylene microporous membrane with the coating liquid, and then the polyethylene microporous membrane was pulled up (EVOH coating). Next, an excess coating liquid adhering to both main surfaces of the polyethylene microporous membrane was removed, and the membrane was dried at normal temperature for 2 hours. Then, the metal frame was removed from the polyethylene microporous membrane. In this way, a hydrophilic composite porous membrane in which both the main surfaces and inner surfaces of pores of the polyethylene microporous membrane were coated with the olefin/vinyl alcohol-based resin was obtained.

### Examples 2 to 7

—Preparation of Polyethylene Microporous Membrane—

A polyethylene microporous membrane was produced in the same manner as in Example 1 except that the composition of the polyethylene solution or the production step for the polyethylene microporous membrane was changed as shown in Table 1. In Examples 3 to 6, after the sheet was conveyed from the methylene chloride bath, methylene chloride was removed by drying in a temperature atmosphere at 40° C., and an annealing treatment was performed while the sheet was conveyed on a roller heated to 120° C.

—Hydrophilization Treatment for Polyethylene Microporous Membrane—

In the same manner as in Example 1, EVOH was applied to the polyethylene microporous membrane to prepare a hydrophilic composite porous membrane. However, in Examples 5 and 6, the EVOH concentration of the coating liquid was 1% by mass.

### Comparative Example 1

—Preparation of Polyethylene Microporous Membrane—

A polyethylene microporous membrane was produced in the same manner as in Example 1 except that the composition of the polyethylene solution and the production step for the polyethylene microporous membrane were changed as shown in Table 1. In Comparative Example 1, after the sheet was conveyed from the methylene chloride bath, methylene chloride was removed by drying in a temperature atmosphere at 40° C., and an annealing treatment was performed while the sheet was conveyed on a roller heated to 120° C.

—Hydrophilization Treatment for Polyethylene Microporous Membrane—

One side of the polyethylene microporous membrane was subjected to a plasma treatment (AP-300 manufactured by Nordson MARCH, output: 150 W, treatment pressure: 400 mTorr, gas flow rate: 160 sccm, treatment time: 45 seconds) to obtain a hydrophilic composite porous membrane.

### Comparative Example 2

—Preparation of Polyethylene Microporous Membrane—

A polyethylene microporous membrane was produced in the same manner as in Example 1 except that the production step for the polyethylene microporous membrane was changed as shown in Table 1.

—Hydrophilization Treatment for Polyethylene Microporous Membrane—

One side of the polyethylene microporous membrane was subjected to a plasma treatment (AP-300 manufactured by Nordson MARCH, output: 150 W, treatment pressure: 400 mTorr, gas flow rate: 160 sccm, treatment time: 45 seconds) to obtain a hydrophilic composite porous membrane.

### Comparative Example 3

—Preparation of Polyethylene Microporous Membrane—

A polyethylene microporous membrane was produced in the same manner as in Example 1 except that the composition of the polyethylene solution and the production step for the polyethylene microporous membrane were changed as shown in Table 1.

—Hydrophilization Treatment for Polyethylene Microporous Membrane—

In the same manner as in Example 1, EVOH was applied to the polyethylene microporous membrane to prepare a hydrophilic composite porous membrane.

### Comparative Example 4

As Comparative Example 4, SYNN0601MNXX104 manufactured by MDI Corporation as a syringe filter was prepared. A porous membrane included in the syringe filter is made of nylon.

### Comparative Example 5

As Comparative Example 5, CA025022 manufactured by Membrane Solutions Co., Ltd. as a syringe filter was prepared. A porous membrane included in the syringe filter is made of cellulose acetate.

<Measurement of Physical Properties of Hydrophilic Composite Porous Membrane>

Using each of the hydrophilic composite porous membranes of Examples 1 to 7 and Comparative Examples 1 to 5 or a comparative porous membrane as a sample, the following physical properties were measured. For each of the hydrophilic composite porous membranes of Comparative Examples 1 and 2, the physical properties of the plasma-treated main surface were measured. For each of porous membranes included in the syringe filters of Comparative Examples 4 and 5, the porous membrane was taken out from the syringe filter, and the physical properties of the main surface on a syringe filter inlet side were measured. The results are shown in Table 2.

[Water Contact Angle]

The hydrophilic composite porous membrane was left in an environment at a temperature of 25° C. and a relative humidity of 60% for 24 hours or more to adjust the humidity. Thereafter, a water droplet of 1 μL of ion-exchanged water was dropped on the surface of the porous membrane with a syringe under an environment at the same temperature and the same humidity, and a contact angle 30 seconds after dropping of the water droplet was measured by a θ/2 method using the fully automatic contact angle meter Drop Master DM 500 (Kyowa Interface Science Co., Ltd.).

[Membrane Thickness t]

The membrane thickness t of the hydrophilic composite porous membrane or the comparative porous membrane and the thickness of the polyethylene microporous membrane were determined by measuring values at 20 points with a contact type membrane thickness meter (manufactured by Mitutoyo Corporation), and averaging the measured values. As a contact terminal, a columnar terminal having a bottom surface with a diameter of 0.5 cm was used. A measurement pressure was 0.1N.

[Average Pore Diameter x]

The average pore diameter x (μm) of the hydrophilic composite porous membrane or the comparative porous membrane was determined by a half dry method specified in ASTM E1294-89 using a perm porometer (model: CFP-1200 AEXL) manufactured by PMI and using Galwick (surface tension: 15.9 dyn/cm) manufactured by PMI as an immersion liquid. A measurement temperature was 25° C., and a measurement pressure was changed in a range of 0 to 600 kPa.

[Bubble point pore diameter y]

The bubble point (BP) pore diameter y (μm) of the hydrophilic composite porous membrane or the comparative porous membrane was determined by a bubble point method defined in ASTM F316-86 and JIS K3832 using a perm porometer (model: CFP-1200 AEXL) manufactured by PMI. However, the value is determined by changing the immersion liquid at the time of the test to Galwick (surface tension: 15.9 dyn/cm) manufactured by PMI. A measurement temperature was 25° C., and a measurement pressure was changed in a range of 0 to 600 kPa.

[Bubble Point Pressure]

The bubble point (BP) pressure of the hydrophilic composite porous membrane or the comparative porous membrane is a value determined by immersing the polyolefin microporous membrane in ethanol, and performing a bubble point test according to a bubble point test method of JIS K3832:1990, provided that a liquid temperature at the time of the test is changed to 24±2° C., and that the applied pressure is increased at a pressure increase rate of 2 kPa/sec.

[Water Flow Rate f]

The hydrophilic composite porous membrane was cut out into a size of 10 cm in the MD direction×10 cm in the TD direction, and set on a stainless steel circular liquid permeation cell having a liquid permeation area of 17.34 cm². One hundred (100) mL of water was allowed to permeate at a differential pressure of 20 kPa, and a time (sec) necessary for 100 mL of water to permeate was measured. The measurement was performed in a temperature atmosphere at a room temperature of 24° C. The water flow rate f (mL/(min·cm²·MPa)) was determined by subjecting the measurement conditions and the measured value to unit conversion.

[Surface Roughness Ra]

An arithmetic average height under the following conditions was measured using a light wave interference type surface roughness meter (Zygo Corporation, NewView 5032) to determine the surface roughness Ra.
Objective lens: 20×Mirau type
Image zoom: 1.0×
FDA Res: Normal or Low
Analysis conditions: After obtainment of data on three places of each sample in a non-contact manner using Stich.app, which is a standard application of Zygo Corporation, the surface roughness was analyzed using Advance Texture. app, which is an optional application for roughness evaluation.

<Evaluation of Performance of Hydrophilic Composite Porous Membrane>

A concentration test was performed using each of the hydrophilic composite porous membranes of Examples 1 to 7 and Comparative Examples 1 to 5. When each of the hydrophilic composite porous membranes of Comparative Examples 1 and 2 was used, the plasma-treated main surface was set to the upstream side. When each of the porous membranes included in the syringe filters of Comparative Example 4 and 5 was used as a concentration membrane, the porous membrane was taken out from the syringe filter, and the main surface on the syringe filter inlet side was set to the upstream side. The results are shown in Table 2. Details of the concentration test are as follows.

As a liquid to be concentrated, a suspension obtained by suspending protein A-modified latex particles (micromer manufactured by micromod Partikeltechnologie GmbH) in a 25 mM MES acid buffer solution (pH 6.0) at 1 ppm was prepared. The latex particles contained as particles are spherical particles having a diameter of 100 nm.

The hydrophilic composite porous membrane was punched into a circle having a diameter of 13 mm with a punch, and installed in a housing of a filter holder (Swinnex 35 manufactured by Merck Millipore). Ten (10) mL of the suspension was collected in a 10 mL-volume syringe (manufactured by Terumo Corporation). A tip of the syringe was connected to the filter holder, and the suspension was allowed to pass through the filter holder. A pressure applied to a plunger was about 30 N. When the plunger was not moved by the pressure, the applied pressure was gradually increased to apply the minimum pressure at which the plunger was moved.

[Treatment Time]

A time (seconds) from a time when the plunger was started to be pushed to a time when the plunger was fully pushed was measured.

[Concentration Rate]

After the plunger was fully pushed, the plunger was reciprocated several times in a state where the filter device faced up and the syringe faced down, and the suspension remaining upstream of the hydrophilic composite porous membrane was recovered. A transmittance of the recovered suspension at a measurement wavelength of 280 nm was quantified with a spectrophotometer (double beam spectrophotometer U-2900 manufactured by Hitachi High-Tech Science Corporation). Concentration rate (%)=Cb±Ca×100 was calculated from a concentration Ca of the particles in the suspension before liquid flow and a concentration Cb of the particles in the recovered suspension.

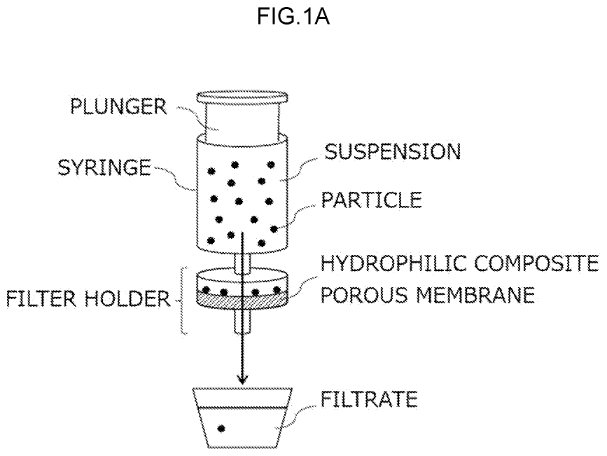

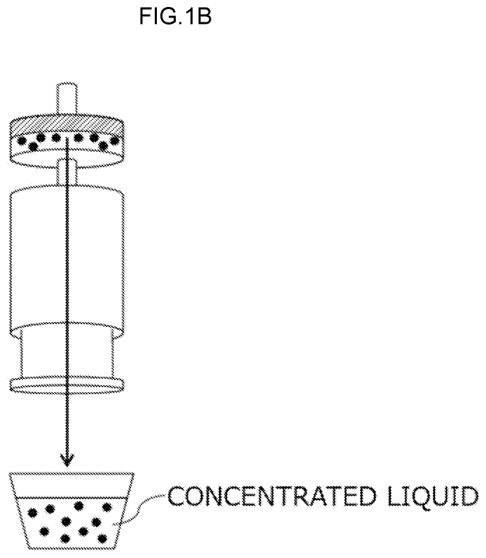

FIGS. 1A and 1B are schematic diagrams showing an instrument and an operation for the concentration test. An arrow in FIG. 1A indicates a direction in which the suspension flows. An arrow in FIG. 1B indicates a direction in which the suspension remaining upstream of the hydrophilic composite porous membrane is recovered.

TABLE 1

| | | | Example | Example | Example | Example | Example | Example | Example | Comparative | Comparative | Comparative |
|---|---|---|---|---|---|---|---|---|---|---|---|---|
| | | | 1 | 2 | 3 | 4 | 5 | 6 | 7 | Example 1 | Example 2 | Example 3 |
| Composition | Decalin | Parts by | 75 | 75 | 75 | 75 | 75 | 75 | 75 | 75 | 75 | 75 |
| of | | mass | | | | | | | | | | |
| polyethylene | UHMWPE | Mw | 4.6 | 4.6 | 4.6 | 4.6 | 4.6 | 4.6 | 4.6 | 4.6 | 4.6 | 4.6 |
| solution | | | million | million | million | million | million | million | million | million | million | million |
| | | Parts by | 3.75 | 3.75 | 7.5 | 5 | 7.5 | 7.5 | 5 | 7.5 | 3.75 | 3.75 |
| | | mass | | | | | | | | | | |
| | HDPE | Mw | 560,000 | 560,000 | 560,000 | 560,000 | 560,000 | 560,000 | 560,000 | 560,000 | 560,000 | 560,000 |
| | | Parts by | 21.25 | 21.25 | 17.5 | 20 | 17.5 | 17.5 | 20 | 17.5 | 21.25 | 21.25 |
| | | mass | | | | | | | | | | |
| | Polymer | % by | 25 | 25 | 25 | 25 | 25 | 25 | 25 | 25 | 25 | 25 |
| | concentration | mass | | | | | | | | | | |
| Extrusion | Die temperature | ° C. | 147 | 149 | 148 | 148 | 149 | 148 | 148 | 148 | 147 | 148 |
| | Cooling | ° C. | 20 | 20 | 20 | 20 | 20 | 20 | 20 | 20 | 20 | 20 |
| | temperature | | | | | | | | | | | |
| | Preliminary | ° C. | 70 | 70 | 70 | 70 | 70 | 70 | 70 | 70 | 70 | 70 |
| | drying | | | | | | | | | | | |
| | temperature | | | | | | | | | | | |
| | Preliminary | Minutes | 10 | 10 | 10 | 10 | 10 | 10 | 10 | 10 | 10 | 10 |
| | drying | | | | | | | | | | | |
| | time | | | | | | | | | | | |
| | Primary | Times | 1.8 | 1.8 | 1.1 | 1.3 | 1.1 | 1.6 | 1.4 | 1.6 | 1.5 | 1.4 |
| | stretching ratio | | | | | | | | | | | |
| | Main drying | ° C. | 57 | 57 | 57 | 57 | 57 | 57 | 57 | 57 | 57 | 57 |
| | temperature | | | | | | | | | | | |
| | Main drying | Minutes | 5 | 5 | 5 | 5 | 5 | 5 | 5 | 5 | 5 | 5 |
| | time | | | | | | | | | | | |
| Stretching | MD stretching | ° C. | 90 | 90 | 90 | 90 | 90 | 90 | 90 | 90 | 90 | 90 |
| | temperature | | | | | | | | | | | |
| | MD stretching | Times | 4 | 4 | 2 | 2 | 6.5 | 4.5 | 3.6 | 4.5 | 3 | 3 |
| | ratio | | | | | | | | | | | |
| | TD stretching | ° C. | 125 | 103 | 130 | 130 | 130 | 125 | 125 | 125 | 125 | 125 |
| | temperature | | | | | | | | | | | |
| | TD stretching | Times | 9 | 9 | 5 | 5 | 13.5 | 9 | 9 | 9 | 9 | 9 |
| | ratio | | | | | | | | | | | |
| | Heat fixation | ° C. | 144 | 120 | 140 | 140 | 142 | 147 | 144 | 147 | 140 | 144 |
| | temperature | | | | | | | | | | | |
| Extraction | Extraction time | Seconds | 60 | 60 | 60 | 60 | 60 | 60 | 60 | 60 | 60 | 60 |
| | Drying | ° C. | 40 | 40 | 40 | 40 | 40 | 40 | 40 | 40 | 40 | 40 |
| | temperature | | | | | | | | | | | |
| | Annealing | ° C. | — | — | 120 | 120 | 120 | 120 | — | 120 | — | — |
| | temperature | | | | | | | | | | | |

| | | | | | | | | | | | |
|---|---|---|---|---|---|---|---|---|---|---|---|
| Hydro- | EVOH coating | Coated | Coated | Coated | Coated | Coated | Coated | Coated | — | — | Coated |
| philization | Plasma treatment | — | — | — | — | — | — | — | One side | One side | — |
| treatment | | | | | | | | | | | |

TABLE 2

| | | | | | | | Water flow | | | | | |
|---|---|---|---|---|---|---|---|---|---|---|---|---|
| | | | Average | | | | rate at | | | | | |
| | | | pore | | | BP pore | differential | | | Surface | Treat- | |
| | Hydro- | Membrane | diameter | | BP | diameter | pressure of | | | rough- | ment | Concen- |
| | philization | thickness t | x | | pressure | y | 20 kPa | Water flow rate f | f/y | ness | time | tration |
| | treatment | [μm] | [μm] | t/x - | [MPa] | [μm] | [mL/min · cm2] | [mL/min · cm2 · MPa] | - | Ra [μm] | [sec.] | rate [%] |
| Example 1 | EVOH | 54 | 0.24 | 226 | 0.05 | 0.93 | 6.8 | 342 | 367 | 0.42 | 45 | 897 |
| | coating | | | | | | | | | | | |
| Example 2 | EVOH | 58 | 0.37 | 156 | 0.02 | 2.18 | 12.0 | 600 | 275 | 0.60 | 29 | 768 |
| | coating | | | | | | | | | | | |
| Example 3 | EVOH | 46 | 0.19 | 241 | 0.09 | 0.61 | 4.7 | 235 | 386 | 0.40 | 63 | 358 |
| | coating | | | | | | | | | | | |
| Example 4 | EVOH | 52 | 0.45 | 115 | 0.06 | 1.10 | 15.0 | 750 | 682 | 0.45 | 25 | 652 |
| | coating | | | | | | | | | | | |
| Example 5 | EVOH | 19 | 0.11 | 181 | 0.18 | 0.27 | 0.9 | 43 | 163 | 0.34 | 57 | 134 |
| | coating | | | | | | | | | | | |
| Example 6 | EVOH | 34 | 0.15 | 230 | 0.12 | 0.52 | 2.5 | 124 | 239 | 0.48 | 82 | 529 |
| | coating | | | | | | | | | | | |
| Example 7 | EVOH | 61 | 0.13 | 470 | 0.12 | 0.45 | 1.9 | 96 | 212 | 0.35 | 90 | 187 |
| | coating | | | | | | | | | | | |
| Comparative | Plasma | 35 | 0.36 | 96 | 0.08 | 0.87 | 9.6 | 478 | 549 | 0.57 | 41 | 68 |
| Example 1 | treatment | | | | | | | | | | | |
| Comparative | Plasma | 49 | 0.79 | 62 | 0.03 | 2.30 | 16.6 | 829 | 361 | 0.46 | 37 | 72 |
| Example 2 | treatment | | | | | | | | | | | |
| Comparative | EVOH | 160 | 0.25 | 640 | 0.05 | 1.03 | 2.0 | 100 | 97 | 0.46 | 182 | 527 |
| Example 3 | coating | | | | | | | | | | | |
| Comparative | None | 155 | 0.26 | 596 | 0.12 | 0.53 | — | — | — | 0.26 | 123 | 96 |
| Example 4 | | | | | | | | | | | | |
| Comparative | None | 144 | 0.21 | 686 | 0.17 | 0.31 | — | — | — | 0.40 | 132 | 98 |
| Example 5 | | | | | | | | | | | | |

As shown in Table 2, the hydrophilic composite porous membranes of the Examples in which the polyolefin microporous membrane was hydrophilized with the olefin/vinyl alcohol-based resin could be used to easily and rapidly concentrate the latex particles having a nano-order size efficiently.

On the other hand, the concentration treatment could be performed satisfactorily in none of the comparative examples.

1. A hydrophilic composite porous membrane comprising:
a polyolefin microporous membrane; and
an olefin/vinyl alcohol-based resin with which at least one main surface and inner surfaces of pores of the polyolefin microporous membrane are coated,
wherein a ratio t/x of a membrane thickness t (μm) to an average pore diameter x (μm), as measured with a perm porometer, is from 50 to 630.

2. The hydrophilic composite porous membrane according to claim 1, wherein the average pore diameter x is from 0.1 μm to 0.5 μm.

3. The hydrophilic composite porous membrane according to claim 1, wherein a bubble point pore diameter y, as measured with a perm porometer, is more than 0.8 μm and equal to or less than 3 μm.

4. The hydrophilic composite porous membrane according to claim 1, wherein a ratio f/y of a water flow rate f (mL/(min·cm²·MPa)) to a bubble point pore diameter y (μm), as measured with a perm porometer, is from 100 to 480.

5. The hydrophilic composite porous membrane according to claim 1, wherein the membrane thickness t is from 10 μm to 150 μm.

6. The hydrophilic composite porous membrane according to claim 1, which has a surface roughness Ra of from 0.3 μm to 0.7 μm.

7. The hydrophilic composite porous membrane according to claim 1, wherein a bubble point pressure is from 0.02 MPa to 0.15 MPa.

8. The hydrophilic composite porous membrane according to claim 1, wherein a water flow rate f is 20 mL/(min·cm²·MPa) or more.
